(19) United States
(12) Patent Application Publication
(10) Pub. No.: US 2022/0134442 A1
(43) Pub. Date: May 5, 2022

(54) THREE-DIMENSIONAL SHAPING APPARATUS

(71) Applicant: SEIKO EPSON CORPORATION, Tokyo (JP)

(72) Inventor: Takeshi MIYASHITA, Sendai-shi (JP)

(21) Appl. No.: 17/452,629

(22) Filed: Oct. 28, 2021

(30) Foreign Application Priority Data
Oct. 30, 2020 (JP) 2020-182877

(51) Int. Cl. B22F 12/49; B22F 12/41; B22F 12/55; B22F 10/366; B22F 7/02; B33Y 30/00

(52) U.S. Cl. CPC B22F 12/49; B22F 12/41; B22F 12/55; B22F 2203/05; B22F 7/02; B33Y 30/00; B22F 10/366

(57) ABSTRACT

A three-dimensional shaping apparatus includes a stage, a first material supply unit that supplies a first material, a second material supply unit that supplies a second material, a laser irradiation unit, and a control unit that controls the laser irradiation unit separately between a first laser irradiation scan and a second laser irradiation scan, wherein when a first material region and a second material region are adjacently disposed in the shaped layer for one layer, the control unit irradiates the first material region with a laser in the first laser irradiation scan, and irradiates the second material region with a laser in the second laser irradiation scan.

The present application is based on, and claims priority from JP Application Serial Number 2020-182877, filed Oct. 30, 2020, the disclosure of which is hereby incorporated by reference herein in its entirety.

### BACKGROUND

### 1. Technical Field

The present disclosure relates to a three-dimensional shaping apparatus.

### 2. Related Art

Heretofore, three-dimensional shaping apparatuses for producing a three-dimensional shaped article by stacking shaped layers have been used. Among these, there is a three-dimensional shaping apparatus that stacks shaped layers using multiple materials. For example, WO 2016/121013 (Patent Document 1) discloses a laser powder additive manufacturing apparatus for producing a three-dimensional shaped article constituted by multiple materials by supplying a resin powder onto a resin or metal substrate and irradiating the resin powder with a laser.

The laser powder additive manufacturing apparatus disclosed in Patent Document 1 supplies a resin powder onto a metal substrate and irradiates the resin powder with a laser, and therefore, the resin powder having a thermal expansion coefficient equal to or lower than a thermal expansion coefficient of the substrate is to be irradiated with the laser. However, when a first material having a small thermal expansion coefficient and a second material having a large thermal expansion coefficient are adjacently disposed in a shaped layer for one layer, and a first material region formed of the first material and a second material region formed of the second material are successively irradiated with a laser, heat is further successively transferred to a region sintered or heated to a high temperature by being irradiated with the laser earlier between the first material region and the second material region from a region irradiated with the laser later between the first material region and the second material region. Therefore, in a region where the first material region and the second material region are adjacent to each other or the like, the shaped layer may be damaged by heat stress due to the laser, the shaped layer may be deformed by heat due to the laser, and so on, and there is a fear that the production accuracy of the three-dimensional shaped article is deteriorated.

### SUMMARY

A three-dimensional shaping apparatus according to the present disclosure for solving the above problem is a three-dimensional shaping apparatus for producing a three-dimensional shaped article by stacking shaped layers, and includes a stage, a first material supply unit that supplies a first material, a second material supply unit that supplies a second material different from the first material, a laser irradiation unit, and a control unit that controls the laser irradiation unit separately between a first laser irradiation scan and a second laser irradiation scan, wherein when a first material region formed by supplying the first material from the first material supply unit and a second material region formed by supplying the second material from the second material supply unit are adjacently disposed in the shaped layer for one layer, the control unit irradiates the first material region with a laser from the laser irradiation unit in the first laser irradiation scan, and irradiates the second material region with a laser from the laser irradiation unit in the second laser irradiation scan.

### BRIEF DESCRIPTION OF THE DRAWINGS

FIG. 1 is a schematic front view showing a configuration of a three-dimensional shaping apparatus of an embodiment of the present disclosure.

FIG. 2 is a schematic front view showing a configuration of a material supply unit of the three-dimensional shaping apparatus in FIG. 1.

FIG. 3 is a schematic perspective view showing a screw of the three-dimensional shaping apparatus in FIG. 1.

FIG. 4 is a schematic plan view showing a state where a shaping material is filled in the screw of the three-dimensional shaping apparatus in FIG. 1.

FIG. 5 is a schematic plan view showing a barrel of the three-dimensional shaping apparatus in FIG. 1.

FIG. 6 is a schematic front view showing a state where a three-dimensional shaped article is produced using the three-dimensional shaping apparatus in FIG. 1.

FIG. 7 is a flowchart of one example of a three-dimensional shaping method using the three-dimensional shaping apparatus in FIG. 1.

FIG. 8 is a graph showing an energy intensity distribution of a laser to be used when laser irradiation is performed using the three-dimensional shaping apparatus in FIG. 1.

FIG. 9 is a graph showing a heat distribution in a depth direction of a material of a laser to be used when laser irradiation is performed using the three-dimensional shaping apparatus in FIG. 1.

### DESCRIPTION OF EXEMPLARY EMBODIMENTS

First, the present disclosure will be schematically described.

A three-dimensional shaping apparatus according to a first aspect of the present disclosure for solving the above problem is a three-dimensional shaping apparatus for producing a three-dimensional shaped article by stacking shaped layers, and includes a stage, a first material supply unit that supplies a first material, a second material supply unit that supplies a second material different from the first material, a laser irradiation unit, and a control unit that controls the laser irradiation unit separately between a first laser irradiation scan and a second laser irradiation scan, and is characterized in that when a first material region formed by supplying the first material from the first material supply unit and a second material region formed by supplying the second material from the second material supply unit are adjacently disposed in the shaped layer for one layer, the control unit irradiates the first material region with a laser from the laser irradiation unit in the first laser irradiation scan, and irradiates the second material region with a laser from the laser irradiation unit in the second laser irradiation scan.

According to this aspect, the laser irradiation unit can be controlled separately between the first laser irradiation scan and the second laser irradiation scan. Then, when the first material region and the second material region are adjacently disposed in the shaped layer for one layer, the first material region can be irradiated with a laser in the first laser irradiation scan, and the second material region can be irradiated with a laser in the second laser irradiation scan. Therefore, it is possible to suppress further successive heat transfer to the region sintered or heated to a high temperature by being irradiated with the laser earlier from the region irradiated with the laser later due to successive irradiation of the first material region and the second material region with the laser. Accordingly, in an adjacent portion between the first material region and the second material region or the like, damage to the shaped layer by heat stress due to the laser or deformation of the shaped layer by heat due to the laser can be suppressed.

The three-dimensional shaping apparatus according to a second aspect of the present disclosure is characterized in that, in the first aspect, a thermal expansion coefficient of the second material is larger than a thermal expansion coefficient of the first material, and the control unit controls the laser irradiation unit so as to execute the second laser irradiation scan for the second material region prior to the first laser irradiation scan for the first material region.

When a shaped layer for one layer is formed using shaping materials having different thermal expansion coefficients, with the irradiation with a laser, the shaped layer is likely to be damaged by heat stress due to the laser. In particular, when a region formed of a shaping material having a small thermal expansion coefficient is irradiated with a laser prior to a region formed of a shaping material having a large thermal expansion coefficient, the region formed of the shaping material having a small thermal expansion coefficient is likely to be damaged with the irradiation of the region formed of the shaping material having a large thermal expansion coefficient with the laser. However, according to this aspect, even when a shaped layer for one layer is formed using the first material and the second material having different thermal expansion coefficients, damage to the shaped layer by heat stress due to the laser can be suppressed.

The three-dimensional shaping apparatus according to a third aspect of the present disclosure is characterized in that, in the second aspect, the first material is a ceramic.

According to this aspect, the first material is a ceramic. A ceramic after sintering is likely to be damaged by heat stress, however, according to this aspect, even when a ceramic is used as the first material, further heat transfer from the second material region, for example, after a ceramic region is sintered can be suppressed, and damage to the ceramic region by heat stress due to the laser can be suppressed.

The three-dimensional shaping apparatus according to a fourth aspect of the present disclosure is characterized in that, in the second or third aspect, the second material is a metal.

According to this aspect, the second material is a metal. A metal is easy to transfer heat to a region adjacent thereto, however, according to this aspect, even when a metal is used as the second material, for example, after the first material region is cooled, the second material region can be irradiated with a laser, and damage to the first material region by heat stress due to the laser can be suppressed. In particular, when a ceramic is used as the first material, damage to a ceramic region by heat stress due to the laser can be effectively suppressed.

The three-dimensional shaping apparatus according to a fifth aspect of the present disclosure is characterized in that, in the first aspect, a sintering temperature of the second material is higher than a melting point of the first material.

In a case where the second material having a sintering temperature higher than a melting point of the first material is used, when the second material is irradiated with a laser, the first material is likely to be deformed. However, according to this aspect, even when the second material having a sintering temperature higher than a melting point of the first material is used, heat transfer from the second material region can be suppressed, for example, when the first material region is in a high temperature state, and deformation of the first material region by heat due to the laser can be suppressed.

The three-dimensional shaping apparatus according to a sixth aspect of the present disclosure is characterized in that, in the fifth aspect, the first material is a resin.

According to this aspect, the first material is a resin. In general, many resins are likely to be deformed by heat, however, according to this aspect, even when a resin is used as the first material, heat transfer from the second material can be suppressed, for example, when a resin region is in a high temperature state, and deformation of the resin region by heat due to the laser can be suppressed.

The three-dimensional shaping apparatus according to a seventh aspect of the present disclosure is characterized in that, in the fifth or sixth aspect, the second material is a metal or a ceramic.

According to this aspect, the second material is a metal or a ceramic. A metal or a ceramic is easy to transfer heat to a region adjacent thereto, however, according to this aspect, even when a metal or a ceramic is used as the second material, for example, after the first material region is cooled, the second material region can be irradiated with a laser, and deformation of the first material region by heat due to the laser can be suppressed.

Hereinafter, embodiments according to the present disclosure will be described with reference to the accompanying drawings. Note that the following drawings are all schematic views, and some constituent members are omitted or simplified. Further, in the respective drawings, an X-axis direction is a horizontal direction, a Y-axis direction is a horizontal direction and also a direction perpendicular to the X-axis direction, and a Z-axis direction is a vertical direction.

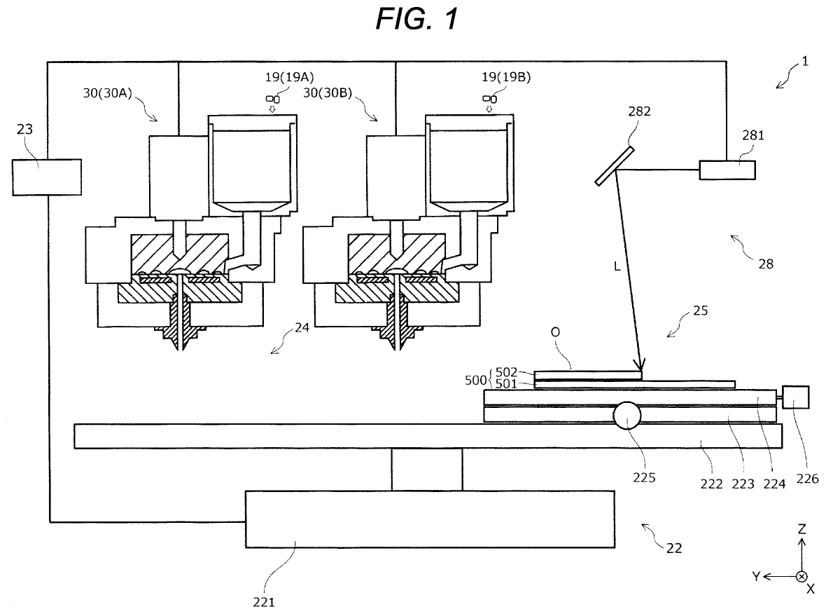

First, the overall configuration of a three-dimensional shaping apparatus 1 of an embodiment of the present disclosure will be described with reference to FIGS. 1 to 5.

The three-dimensional shaping apparatus 1 of the present embodiment is a three-dimensional shaping apparatus for producing a three-dimensional shaped article O by stacking shaped layers 500 using a first material Oa and a second material Ob, and sintering both the first material Oa and the second material Ob with a laser L. As shown in FIG. 1, the three-dimensional shaping apparatus 1 of the present embodiment includes two material supply units 30 that supply a material for forming the shaped layers 500, a stage unit 22 as a stage for shaping the three-dimensional shaped article O, and a laser irradiation unit 28 capable of irradiating the shaped layer with the laser L. In addition, the three-dimensional shaping apparatus 1 includes a control unit 23 that controls driving of the respective constituent members of the three-dimensional shaping apparatus 1 such as the material supply units 30, the stage unit 22, and the laser irradiation unit 28.

The three-dimensional shaping apparatus 1 of the present embodiment includes a first material supply unit 30A that supplies the first material Oa and a second material supply unit 30B that supplies the second material Ob as the material supply units 30. As the second material Ob, a material different from the first material Oa is used. For example, a material having a thermal expansion coefficient larger than a thermal expansion coefficient of the first material Oa is used. Further, for example, a material having a sintering temperature higher than a melting point of the first material Oa is used. In the three-dimensional shaping apparatus 1 of the present embodiment, a pellet 19 can be used as a shaping material for shaping the three-dimensional shaped article O. That is, a pellet 19A containing the first material Oa is used in the first material supply unit 30A, and a pellet 19B containing the second material Ob is used in the second material supply unit 30B. In the pellet 19A, another material such as a binder may be contained other than the first material Oa, and in the pellet 19B, another material such as a binder may be contained other than the second material Ob. Here, in the three-dimensional shaping apparatus 1 of the present embodiment, the first material supply unit 30A and the second material supply unit 30B have exactly the same configuration.

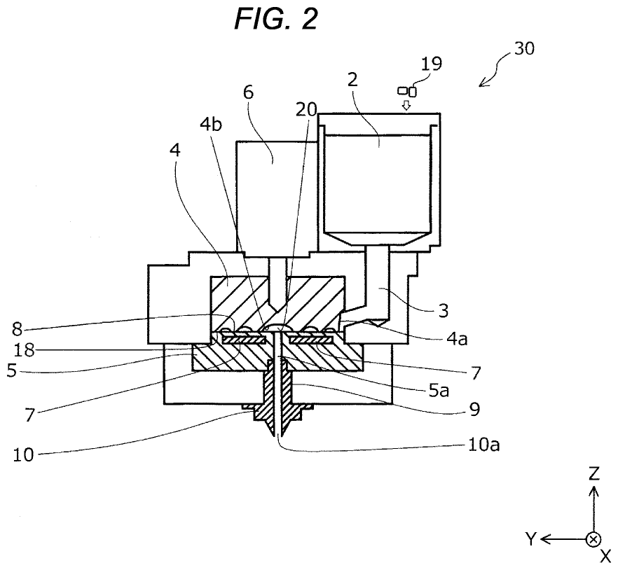

FIG. 2 shows the material supply unit 30, however, the first material supply unit 30A and the second material supply unit 30B have exactly the same configuration, and therefore, FIG. 2 corresponds to both the first material supply unit 30A and the second material supply unit 30B. As shown in FIG. 2, the material supply unit 30 includes a hopper 2 that stores the pellet 19 as the shaping material for shaping the three-dimensional shaped article O. The pellet 19 stored in the hopper 2 is supplied to a circumferential face 4a of a screw 4 that is a flat screw having a substantially columnar shape through a supply pipe 3.

The three-dimensional shaping apparatus 1 of the present embodiment has a configuration in which the pellet 19 is used as the shaping material for shaping the three-dimensional shaped article O, and the shaping material is ejected while plasticizing the shaping material by the flat screw, however, the present disclosure is not limited to the three-dimensional shaping apparatus 1 having such a configuration. For example, a configuration in which the three-dimensional shaped article O is shaped by continuously ejecting a filament that is a linear shaping material made of a resin or a metal filament in which a resin material is mixed in a metal powder from an ejection section while melting the filament, or the like may be adopted. Further, a configuration in which the three-dimensional shaped article O is shaped by ejecting a fluid in which the first material Oa or the second material Ob is dissolved in a solvent or dispersed in a dispersion medium from an ejection section, or the like may be adopted.

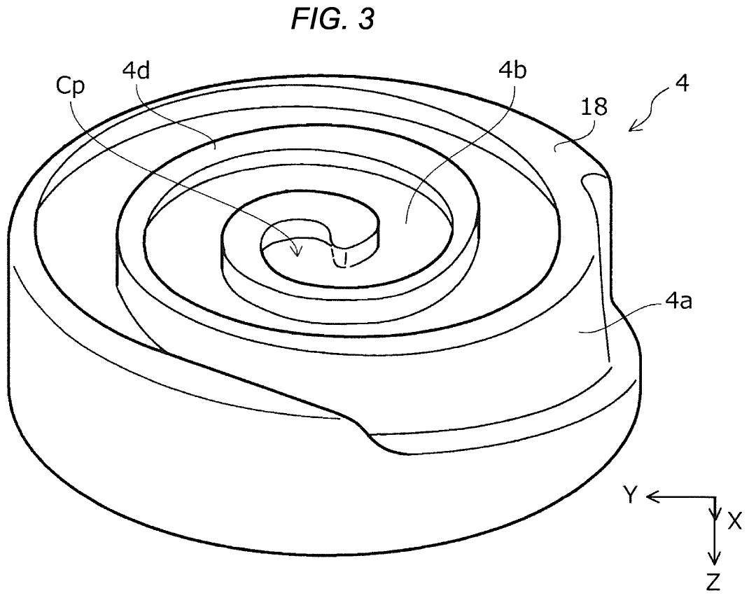

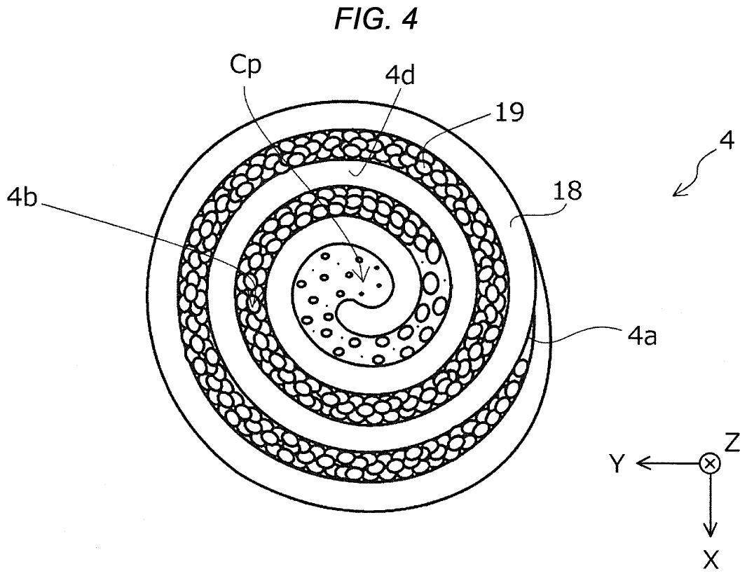

As shown in FIG. 3, in a grooved face 18 that is a bottom face of the screw 4, a groove 4b in a spiral shape extending from the circumferential face 4a to a central portion Cp is formed. In other words, a rib 4d formed with the formation of the groove 4b forms the grooved face 18. The three-dimensional shaping apparatus 1 of the present embodiment supplies the pellet 19 from the circumferential face 4a to the central portion Cp while plasticizing the pellet 19 as shown in FIG. 4 by rotating the screw 4 with a direction along the Z-axis direction as the rotational axis by a driving motor 6 shown in FIG. 2. Although not shown in FIG. 1, in order to prevent the temperature of the driving motor 6 from increasing, cooling water circulates in the vicinity of the driving motor 6.

As shown in FIG. 2, at a position opposed to the grooved face 18 of the screw 4, a barrel 5 is provided with a predetermined interval. In the vicinity of an opposed face 8 that is an upper face of the barrel 5 and is opposed to the grooved face 18, a heating section 7 is provided. Since the screw 4 and the barrel 5 have such a configuration, by rotating the screw 4, the pellet 19 is supplied to a space portion 20 formed between the grooved face 18 of the screw 4 and the opposed face 8 of the barrel 5 as well as corresponding to the position of the groove 4b, and the pellet 19 moves from the circumferential face 4a to the central portion Cp. When the pellet 19 moves in the space portion 20 by the groove 4b, the pellet 19 is melted by heat of the heating section 7, and also is pressurized by a pressure caused by the movement in the narrow space portion 20. By plasticizing the pellet 19 in this manner, the pellet 19 is supplied to a nozzle 10a through a communication hole 5a and ejected from the nozzle 10a.

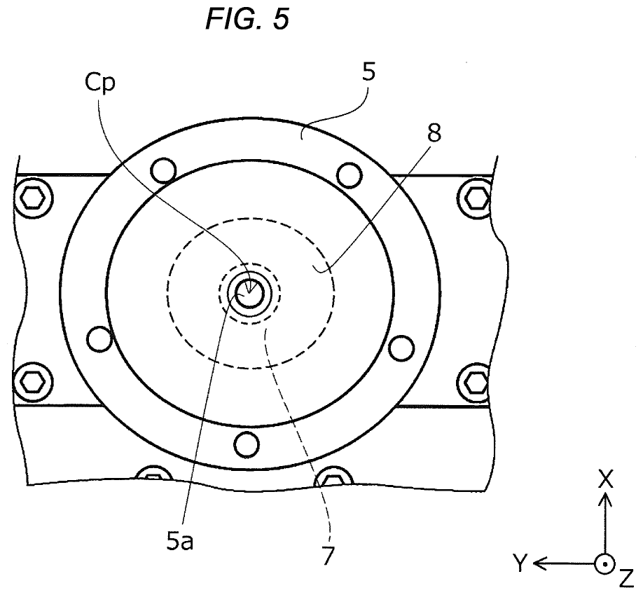

As shown in FIG. 5 or the like, in the central portion Cp of the barrel 5 in plan view, the communication hole 5a that is a movement path of the molten pellet 19 is formed. As shown in FIG. 2, the communication hole 5a is coupled to the nozzle 10a of an ejection section 10 that ejects the shaping material. The communication hole 5a is provided with an unillustrated filter. Although not formed in the barrel 5 of the present embodiment, a groove to be coupled to the communication hole 5a may be formed in the opposed face 8 of the barrel 5. By forming a groove to be coupled to the communication hole 5a in the opposed face 8, the shaping material sometimes tends to gather toward the communication hole 5a.

Here, the ejection section 10 is configured to be able to continuously eject the shaping material in a fluid state by being plasticized from the nozzle 10a. As shown in FIG. 2, the ejection section 10 is provided with a heater 9 for adjusting the viscosity of the shaping material to a desired value. The shaping material to be ejected from the ejection section 10 is ejected in a linear shape. Then, by ejecting the shaping material in a linear shape from the ejection section 10, the shaped layer 500 is formed.

The three-dimensional shaping apparatus 1 of the present embodiment includes the material supply unit 30 including the hopper 2, the supply pipe 3, the screw 4, the barrel 5, the driving motor 6, the ejection section 10, etc. The three-dimensional shaping apparatus 1 of the present embodiment is configured to include one first material supply unit 30A that ejects the first material Oa and one second material supply unit 30B that ejects the second material Ob, but may be configured to include a plurality of at least either first material supply units 30A or second material supply units 30B.

Further, as shown in FIG. 1, the three-dimensional shaping apparatus 1 of the present embodiment includes the stage unit 22 for placing the shaped layer 500 formed by ejection from the material supply unit 30. The stage unit 22 includes a base portion 221, a first table 222, a second table 223, and a third table 224. The first table 222 has a size extending from a shaped layer forming region 24 by the material supply unit 30 to a laser irradiation region 25 by the laser irradiation unit 28 to be described in detail later in the Y-axis direction, and the second table 223 can move along the Y-axis direction with respect to the first table 222 by a motor 225 under the control of the control unit 23. Further, the third table 224 can move along the X-axis direction with respect to the second table 223 by a motor 226 under the control of the control unit 23. Note that there is no particular restriction on the configuration of the stage unit 22, and for example, a table and a motor for moving the second table 223 and the third table 224 from the shaped layer forming region 24 to the laser irradiation region 25 may be further additionally provided.

The three-dimensional shaping apparatus 1 of the present embodiment is configured to be able to move the second table 223 and the third table 224 from the shaped layer forming region 24 to the laser irradiation region 25 by moving the second table 223 along the Y-axis direction with respect to the first table 222. By locating the second table 223 and the third table 224 in the shaped layer forming region 24, the shaped layer 500 is formed by the material supply unit 30, and by locating the second table 223 and the third table 224 in the laser irradiation region 25, laser irradiation is performed by the laser irradiation unit 28.

The material supply unit 30 is configured to be able to move along the Z-axis direction by an unillustrated motor as the shaped layers 500 are stacked in the shaped layer forming region 24, and also the laser irradiation unit is configured to be able to move along the Z-axis direction by an unillustrated motor as the shaped layers 500 are stacked in the laser irradiation region 25. Since the three-dimensional shaping apparatus 1 of the present embodiment has such a configuration, the shaped layer 500 can be formed on the third table 224 while relatively moving the stage unit 22 and the material supply unit 30 in the shaped layer forming region 24, and also the shaped layer 500 formed on the third table 224 can be irradiated with the laser L at a desired position while relatively moving the stage unit 22 and the laser irradiation unit 28 in the laser irradiation region 25. Control of the arrangement of the stage unit 22 and the material supply unit 30 and control of the arrangement of the stage unit 22 and the laser irradiation unit 28 are both performed by the control unit 23.

As shown in FIG. 1, the laser irradiation unit 28 includes a laser irradiation section 281 and a Galvano mirror 282. The laser irradiation unit 28 irradiates the laser L by oscillating the laser L at a predetermined output power from the laser irradiation section 281 based on a control signal from the control unit 23. The laser L is irradiated onto the shaped layer 500 and sinters and solidifies, for example, a metal powder or the like contained in the shaped layer 500. At this time, a binder or the like contained in the shaped layer 500 is simultaneously evaporated by heat of the laser L. The laser L is not particularly limited, but a fiber laser has an advantage that the absorption efficiency into a metal or the like is high, and therefore is favorably used. Further, a Q-switched and pulse-controlled YAG laser may also be used.

Here, the first material Oa and the second material Ob are not particularly limited, but for example, shaping materials can be formed such that the thermal expansion coefficient of the second material Ob is larger than the thermal expansion coefficient of the first material Oa. When the shaped layer 500 for one layer is formed using shaping materials having different thermal expansion coefficients, with the irradiation with the laser, the shaped layer 500 is likely to be damaged by heat stress due to the laser L. In particular, when a region formed of a shaping material having a small thermal expansion coefficient is irradiated with a laser prior to a region formed of a shaping material having a large thermal expansion coefficient, the region formed of the shaping material having a small thermal expansion coefficient is likely to be damaged with the irradiation of the region formed of the shaping material having a large thermal expansion coefficient with the laser. However, the three-dimensional shaping apparatus 1 of the present embodiment controls the laser irradiation unit 28 so as to execute the second laser irradiation scan for the second material region R2 prior to the first laser irradiation scan for the first material region R1 under the control of the control unit 23 described later. According to this, even when the shaped layer 500 for one layer is formed using the first material Oa and the second material Ob having different thermal expansion coefficients, the three-dimensional shaping apparatus 1 of the present embodiment can suppress damage to the shaped layer 500 by heat stress due to the laser L.

Specifically, for example, as the first material Oa, a ceramic can be preferably used. A ceramic after sintering is likely to be damaged by heat stress, however, even when a ceramic is used as the first material Oa, the three-dimensional shaping apparatus 1 of the present embodiment can suppress further heat transfer from the second material region R2, for example, after a ceramic region as the first material region R1 is sintered, and can suppress damage to the ceramic region by heat stress due to the laser L.

Further, as the second material Ob, a metal can be preferably used. A metal is easy to transfer heat to a region adjacent thereto, however, even when a metal is used as the second material Ob, the three-dimensional shaping apparatus 1 of the present embodiment can irradiate the second material region R2 with a laser, for example, after the first material region R1 is cooled, and can suppress damage to the first material region R1 by heat stress due to the laser L. In particular, when a ceramic is used as the first material Oa, damage to a ceramic region by heat stress due to the laser L can be effectively suppressed.

Further, for example, a configuration in which the sintering temperature of the second material Ob is higher than the melting point of the first material Oa can be adopted. In a case where the second material Ob having a sintering temperature higher than the melting point of the first material Oa is used, when the second material Ob is irradiated with a laser, the first material Oa is likely to be deformed. However, the three-dimensional shaping apparatus 1 of the present embodiment controls the laser irradiation unit 28 separately between the first laser irradiation scan for the first material region R1 and the second laser irradiation scan for the second material region R2 under the control of the control unit 23 described later. According to this, even when the second material Ob having a sintering temperature higher than the melting point of the first material Oa is used, the three-dimensional shaping apparatus 1 of the present embodiment can suppress heat transfer from the second material region R2, for example, when the first material region R1 is in a high temperature state, and can suppress deformation of the first material region R1 by heat due to the laser L.

Specifically, for example, as the first material Oa, a resin can be preferably used. In general, many resins are likely to be deformed by heat, however, even when a resin is used as the first material Oa, the three-dimensional shaping apparatus 1 of the present embodiment can suppress heat transfer from the second material Ob, for example, when a resin region as the first material region R1 is in a high temperature state, and can suppress deformation of the resin region by heat due to the laser L.

Further, as the second material Ob, a metal or a ceramic can be preferably used. A metal or a ceramic is easy to transfer heat to a region adjacent thereto, however, even when a metal or a ceramic is used as the second material Ob, the three-dimensional shaping apparatus 1 of the present embodiment can irradiate the second material region R2 with a laser, for example, after the first material region R1 is cooled, and can suppress deformation of the first material region R1 by heat due to the laser L.

However, as described above, the first material Oa and the second material Ob are not particularly limited, and various materials may be used other than a metal, a ceramic, a resin, etc. Further, two or more types thereof may be mixed and used.

Specific examples of the metal or the ceramic that can be used in the first material Oa and the second material Ob include various metals such as aluminum, titanium, iron, copper, magnesium, a stainless steel, and a maraging steel, various metal oxides such as silica, alumina, titanium oxide, zinc oxide, zirconium oxide, tin oxide, magnesium oxide, and potassium titanate, various metal hydroxides such as magnesium hydroxide, aluminum hydroxide, and calcium hydroxide, various metal nitrides such as silicon nitride, titanium nitride, and aluminum nitride, various metal carbides such as silicon carbide and titanium carbide, various metal sulfides such as zinc sulfide, various metal carbonates such as calcium carbonate and magnesium carbonate, various metal sulfates such as calcium sulfate and magnesium sulfate, various metal silicates such as calcium silicate and magnesium silicate, various metal phosphates such as calcium phosphate, various metal borates such as aluminum borate and magnesium borate, composite compounds and the like thereof, and gypsum (various hydrates of calcium sulfate and anhydrous calcium sulfate).

Further, examples of the resin that can be used in the first material Oa and the second material Ob include an acrylic resin, an epoxy resin, a silicone resin, a cellulosic resin, and synthetic resins. Additional examples thereof include thermoplastic resins such as PLA (polylactic acid), PA (polyamide), and PPS (polyphenylene sulfide). When a resin is used as the second material Ob to be sintered by laser irradiation, a heat-resistant resin called a super engineering plastic such as PEEK (polyether ether ketone) can be preferably used. Further, the material may be formed into a pellet state or the like in which the resin is contained together with a metal or a ceramic. Further, the above-mentioned metal, ceramic, or resin in a fine particle state instead of a pellet state may be dissolved or dispersed in a solvent or a dispersion medium. A dissolving agent such as a solvent or a dispersion medium or a binder is generally removed by drying before irradiation with the laser L or is decomposed with irradiation with the laser L and disappears.

Examples of the solvent or the dispersion medium not only include various types of water such as distilled water, pure water, and RO water, but also include alcohols such as methanol, ethanol, 2-propanol, 1-butanol, 2-butanol, octanol, ethylene glycol, diethylene glycol, and glycerin, ethers (cellosolves) such as ethylene glycol monomethyl ether (methyl cellosolve), esters such as methyl acetate, ethyl acetate, butyl acetate, and ethyl formate, ketones such as acetone, methyl ethyl ketone, diethyl ketone, methyl isobutyl ketone, methyl isopropyl ketone, and cyclohexanone, aliphatic hydrocarbons such as pentane, hexane, and octane, cyclic hydrocarbons such as cyclohexane and methylcyclohexane, aromatic hydrocarbons having a long-chain alkyl group and a benzene ring such as benzene, toluene, xylene, hexyl benzene, heptyl benzene, octyl benzene, nonyl benzene, decyl benzene, undecyl benzene, dodecyl benzene, tridecyl benzene, and tetradecyl benzene, halogenated hydrocarbons such as methylene chloride, chloroform, carbon tetrachloride, and 1,2-dichloroethane, aromatic heterocycles containing any one of pyridine, pyrazine, furan, pyrrole, thiophene, and methyl pyrrolidone, nitriles such as acetonitrile, propionitrile, and acrylonitrile, amides such as N,N-dimethylamide and N,N-dimethylacetamide, carboxylates, and other various types of oils. The solvent or the dispersion medium is generally removed by drying before irradiation with the laser L.

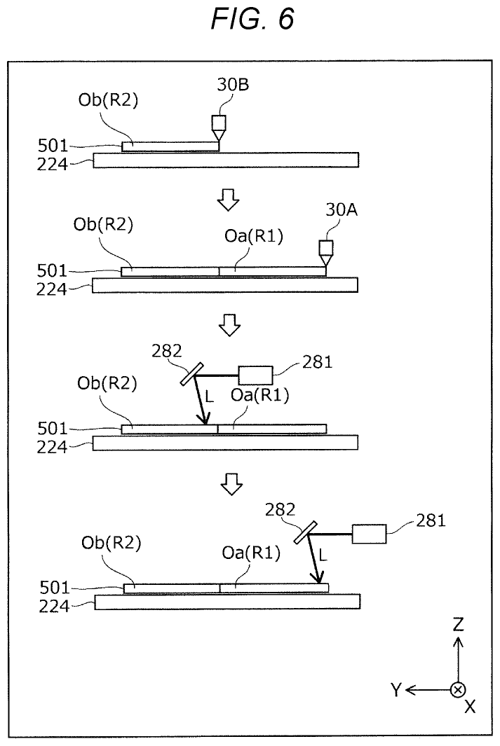

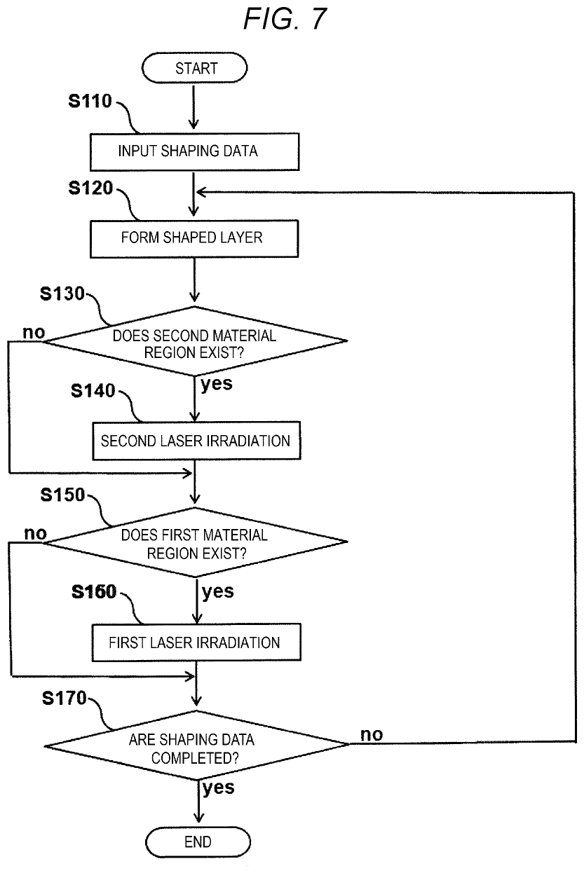

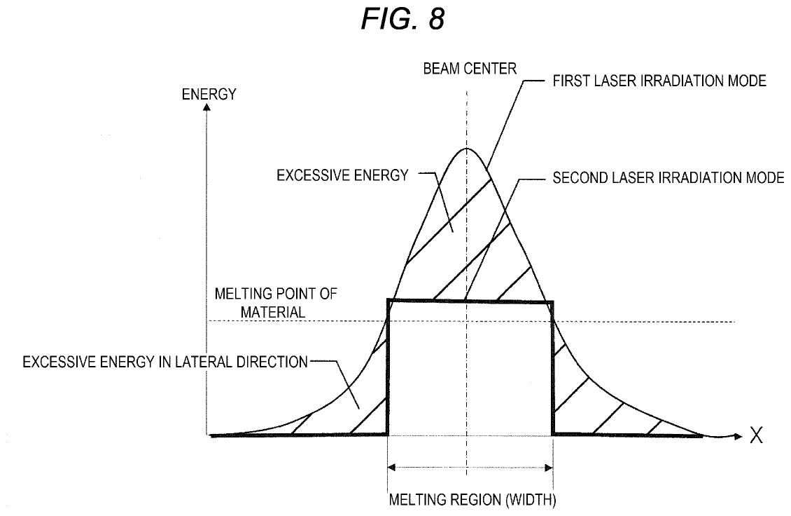

Next, one example of a three-dimensional shaping method to be executed using the above-mentioned three-dimensional shaping apparatus 1 will be described using the flowchart in FIG. 7 with reference to FIGS. 6 and 8. The three-dimensional shaping method of the present embodiment is an example when a ceramic is used as the first material Oa and a metal is used as the second material Ob. First, in Step S110, the three-dimensional shaping apparatus 1 inputs shaping data from an unillustrated external computer or the like.

Subsequently, in Step S120, the shaped layer 500 for one layer is formed based on the shaping data input in Step S110. Here, the topmost state diagram in FIG. 6 shows a state where the second material region R2 as a shaped layer 501 being a first layer composed of the second material Ob is formed on the third table 224 by the second material supply unit 30B. Then, the second state diagram from the top in FIG. 6 shows a state where the first material region R1 as the shaped layer 501 being the first layer composed of the first material Oa is formed adjacent to the second material region R2 on the third table 224 by the first material supply unit 30A. In the second state diagram from the top in FIG. 6, a state where the shaped layer 501 being the first layer composed of the first material Oa and the second material Ob is formed on the third table 224 is shown, however, there is also a case where the shaped layer 501 being the first layer composed only of the first material Oa is formed on the third table 224, or a case where the shaped layer 501 being the first layer composed only of the second material Ob is formed on the third table 224. Further, in the present embodiment, the second material region R2 is formed prior to the formation of the first material region R1, however, the formation order thereof may be reversed.

Subsequently, in Step S130, it is determined by the control unit 23 whether or not the second material region R2 exists in the shaped layer 500 for one layer formed in Step S120. When it is determined that the second material region R2 exists in Step S130, the process proceeds to Step S140, and the second material region R2 is sintered by irradiating the second material region R2 with the laser L in the second laser irradiation scan corresponding to laser irradiation in a one-time scan, and then, the process proceeds to Step S150. On the other hand, when it is determined that the second material region R2 does not exist in Step S130, the process proceeds to Step S150 without proceeding to Step S140. The third state diagram from the top in FIG. 6 shows a state where it is determined that the second material region R2 exists in Step S130, and the second material region R2 is sintered by irradiating the second material region R2 with the laser L in Step S140.

In Step S150, it is determined by the control unit 23 whether or not the first material region R1 exists in the shaped layer 500 for one layer formed in Step S120. When it is determined that the first material region R1 exists in Step S150, the process proceeds to Step S160, and the first material region R1 is sintered by irradiating the first material region R1 with the laser L in the first laser irradiation scan corresponding to laser irradiation in a one-time scan, and then, the process proceeds to Step S170. On the other hand, when it is determined that the first material region R1 does not exist in Step S150, the process proceeds to Step S170 without proceeding to Step S160. The lowermost state diagram in FIG. 6 shows a state where it is determined that the first material region R1 exists in Step S150, and the first material region R1 is sintered by irradiating the first material region R1 with the laser L in Step S160.

In the present embodiment, a ceramic is used as the first material Oa and a metal is used as the second material Ob. Therefore, in order to suppress transfer of heat due to the laser L to the ceramic region by performing laser irradiation for the metal region adjacent thereto after sintering the ceramic, laser irradiation is performed for the second material region R2 prior to the first material region R1. However, laser irradiation may be performed for the first material region R1 prior to the second material region R2 depending on the shaping material to be used.

Here, in the second laser irradiation in Step S140 and in the first laser irradiation in Step S160, laser irradiation may be performed using a laser having the same waveform and the same pulse width, however, laser irradiation may be performed using a laser having a different waveform or a different pulse width. For example, in the second laser irradiation in Step S140, laser irradiation may be performed in a laser irradiation mode in which heat diffusion to the surroundings is smaller than in the first laser irradiation in Step S160. Specifically, for example, in the second laser irradiation in Step S140, a laser with a shorter pulse width than in the first laser irradiation in Step S160 can be used. By using the laser L with a short pulse width, heat diffusion can be reduced. This is because as the pulse width is shortened, energy can be collected at a pinpoint.

Further, for example, it is also possible to use the laser L having an energy intensity distribution with a top-hat profile in the second laser irradiation in Step S140, and to use the laser L having an energy intensity distribution of a Gaussian distribution in the first laser irradiation in Step S160. FIG. 8 is a graph showing examples of energy intensity distributions of the laser L having an energy intensity distribution with a top-hat profile and the laser L having an energy intensity distribution of a Gaussian distribution.

Here, the laser L having an energy intensity distribution with a top-hat profile is formed by integrating a lens system (a unit that converts a Gaussian distribution to a distribution with a top-hat profile) using a diffractive optical element (DOE) or the like capable of converting a laser profile to a top-hat distribution into an optical system of a laser light source having a Gaussian distribution generally adopted in a selective laser sintering (SLS) system or a selective mask sintering (SMS) system. However, the lens system is not particularly limited, and can be appropriately selected according to an intended purpose, and for example, StarLite (device name), manufactured by Ophir Optronics Solutions, Ltd., or the like can be used.

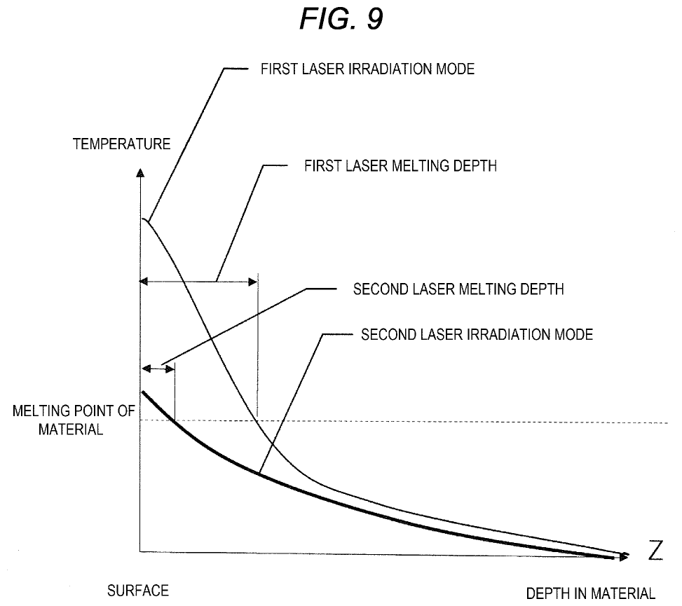

By using the laser L having an energy intensity distribution with a top-hat profile, as compared to a case where the laser L having an energy intensity distribution of a Gaussian distribution is used, a thermal energy to be applied to a meltable region with a constant width can be evenly applied, supply of an excessive thermal energy as in the case of a Gaussian distribution is suppressed, and heat diffusion over a wide range can be suppressed. This is because as also indicated in the graphs of an energy distribution shown in FIG. 8 and a heat distribution in a depth direction of a material shown in FIG. 9, by using the laser L having an energy intensity distribution with a top-hat profile, a thermal energy to be applied to a meltable region with a constant width can be evenly applied in an amount necessary for melting, supply of an excessive thermal energy as in the case of a Gaussian distribution is suppressed, and heat diffusion over a wide range can be suppressed.

As described above, after Step S160 is completed, the process proceeds to Step S170. In Step S170, it is determined by the control unit 23 whether or not the three-dimensional shaping based on the shaping data input in Step S110 is all completed. When it is determined that the three-dimensional shaping based on the shaping data input in Step S110 is all completed, the three-dimensional shaping method of the present embodiment is terminated. On the other hand, when it is determined that the three-dimensional shaping based on the shaping data input in Step S110 is not completed, the process returns to Step S120, and the process from Step S120 to Step S170 is repeated for all the desired shaped layers 500 in the order of the shaped layer 501 being the first layer, the shaped layer 502 being the second layer, . . . , until it is determined that the three-dimensional shaping based on the shaping data input in Step S110 is all completed. Here, when the ceramic regions are in contact with each other between the upper layer and the lower layer, and the metal region in the upper layer is irradiated with the laser, the adhesion at the stacking interface in the ceramic regions between the upper layer and the lower layer is improved due to the heat generated by irradiation of the metal region.

In this manner, when the first material region R1 formed by supplying the first material Oa from the first material supply unit 30A and the second material region R2 formed by supplying the second material Ob from the second material supply unit 30B are adjacently disposed in the shaped layer 500 for one layer, the control unit 23 separates the laser irradiation scan between the first material region R1 and the second material region R2. In other words, the first material region R1 is irradiated with the laser L from the laser irradiation unit 28 in a first laser irradiation scan corresponding to Step S160, and the second material region R2 is irradiated with the laser L from the laser irradiation unit 28 in a second laser irradiation scan corresponding to Step S140.

In this manner, the three-dimensional shaping apparatus 1 of the present embodiment controls the laser irradiation unit 28 separately between the first laser irradiation scan and the second laser irradiation scan in which laser irradiation is performed not successively to the first laser irradiation scan. Then, when the first material region R1 and the second material region R2 are adjacently disposed in the shaped layer 500 for one layer, the three-dimensional shaping apparatus 1 of the present embodiment irradiates the first material region R1 with the laser L in the first laser irradiation scan and irradiates the second material region R2 with the laser L in the second laser irradiation scan. Therefore, by performing three-dimensional shaping using the three-dimensional shaping apparatus 1 of the present embodiment, it is possible to suppress further successive heat transfer to the region sintered or heated to a high temperature by being irradiated with the laser L earlier from the region irradiated with the laser L later due to successive irradiation of the first material region R1 and the second material region R2 with the laser L. Accordingly, in an adjacent portion between the first material region R1 and the second material region R2 or the like, the three-dimensional shaping apparatus 1 of the present embodiment can suppress damage to the shaped layer 500 by heat stress due to the laser L or deformation of the shaped layer 500 by heat due to the laser L. Note that the “heat stress” means a rapid temperature change and corresponds to a case where a rapid volume change is caused accompanying the rapid temperature change, or the like.

The present disclosure is not limited to the above-mentioned embodiments, but can be realized in various configurations without departing from the gist thereof. The technical features in the embodiments corresponding to the technical features in the respective aspects described in “SUMMARY” of the present disclosure may be appropriately replaced or combined for solving part or all of the problems described above or achieving part or all of the effects described above. Further, the technical features may be appropriately deleted unless they are described as essential features in the present specification.

What is claimed is:

1. A three-dimensional shaping apparatus for producing a three-dimensional shaped article by stacking shaped layers, comprising:
a stage;
a first material supply unit that supplies a first material;
a second material supply unit that supplies a second material different from the first material;
a laser irradiation unit; and
a control unit that controls the laser irradiation unit separately between a first laser irradiation scan and a second laser irradiation scan, wherein
when a first material region formed by supplying the first material from the first material supply unit and a second material region formed by supplying the second material from the second material supply unit are adjacently disposed in the shaped layer for one layer, the control unit irradiates the first material region with a laser from the laser irradiation unit in the first laser irradiation scan, and irradiates the second material region with a laser from the laser irradiation unit in the second laser irradiation scan.

2. The three-dimensional shaping apparatus according to claim 1, wherein
a thermal expansion coefficient of the second material is larger than a thermal expansion coefficient of the first material, and
the control unit controls the laser irradiation unit so as to execute the second laser irradiation scan for the second material region prior to the first laser irradiation scan for the first material region.

3. The three-dimensional shaping apparatus according to claim 2, wherein the first material is a ceramic.

4. The three-dimensional shaping apparatus according to claim 2, wherein the second material is a metal.

5. The three-dimensional shaping apparatus according to claim 1, wherein a sintering temperature of the second material is higher than a melting point of the first material.

6. The three-dimensional shaping apparatus according to claim 5, wherein the first material is a resin.

7. The three-dimensional shaping apparatus according to claim 5, wherein the second material is a metal or a ceramic.
